(19) United States
(12) Patent Application Publication
(10) Pub. No.: US 2013/0242896 A1
(43) Pub. Date: Sep. 19, 2013

(54) METHOD AND APPARATUS FOR RECEIVING A SIGNAL IN A WIRELESS COMMUNICATION SYSTEM THAT SUPPORTS MU-MIMO SCHEME

(71) Applicant: LG ELECTRONICS INC., Seoul (KR)

(72) Inventors: Hyukmin SON, Anyang-si (KR); Yongsam KIM, Anyang-si (KR); June JANG, Anyang-si (KR)

(73) Assignee: LG ELECTRONICS INC., Seoul (KR)

(21) Appl. No.: 13/772,129

(22) Filed: Feb. 20, 2013

Related U.S. Application Data
(60) Provisional application No. 61/612,948, filed on Mar. 19, 2012.

(30) Foreign Application Priority Data
Nov. 20, 2012 (KR) 10-2012-0131559

(51) Int. Cl. H04W 72/08

(52) U.S. Cl. CPC H04W 72/085
USPC 370/329

(57) ABSTRACT

A method and apparatus for receiving a signal in a wireless communication system, which supports MU-MIMO scheme, is disclosed to maximize a signal-to-interference and noise ratio (SINR) for a received signal. The method for receiving a signal through a user equipment in a wireless communication system, which supports multi-user-MIMO (MU-MIMO) scheme, comprises the steps of calculating a channel matrix on the basis of a reference signal included in a signal received from a base station; calculating a first vector having maximum channel gain in a vector space formed by the channel matrix; determining a second vector, which minimizes a quantization error with the channel matrix, by using a precoding codebook; calculating a third vector located between the first vector and the second vector, indicating an effective channel having a maximum signal-to-interference plus noise ratio (SINR) for the received signal; and processing the received signal by using a received weight vector determined on the basis of the third vector.

### CROSS-REFERENCE TO RELATED APPLICATIONS

Pursuant to 35 U.S.C. §119, this application claims the benefit of earlier filing date and right of priority to Korean Application No. 10-2012-0131559, filed on November 20, 2012, and also claims the benefit of U.S. Provisional Application Ser. No. 61/612,948, filed on Mar. 19, 2012, the contents of which are all hereby incorporated by reference herein in their entirety.

### BACKGROUND OF THE INVENTION

1. Field of the Invention

The present invention relates to a wireless communication system, and more particularly, to a method and apparatus for receiving a signal in a wireless communication system, which supports MU-MIMO scheme, to maximize a signal-to-interference plus noise ratio (SINR) for a received signal.

2. Discussion of the Related Art

One of methods for improving efficiency in data transmission in a wireless communication system may include a multi-input multi-output (MIMO) technology. The MIMO system may be divided into a single user-MIMO (SU-MIMO) system and a multi-user-MIMO (MU-MIMO) system depending on whether respective data may be transmitted to several users at the same time by using the same band. The MU-MIMO system, which may transmit different data to several users at the same time by using the same band, is known that frequency efficiency higher than that of the SU-MIMO system may be obtained by multi-user diversity gain and spatial multiplexing gain.

The MU-MIMO system may be divided into an open-loop system and a closed-loop system, wherein the open-loop system is that a base station performs communication in a state that it does not know a channel status, and the closed-loop system is that a base station performs communication with reference to channel information fed back from a user equipment. Generally, the closed-loop system, which may approximate to theoretical transmission capacity by using an independent modulation and coding scheme in accordance with a channel status per transmitting antenna, is mainly used.

In the closed-loop MU-MIMO system, the user equipment may use a codebook to transmit channel information to a base station. Each codeword constituting a codebook represents different channel statuses for a channel formed between the base station and the user equipment. The user equipment performs channel estimation by using a reference signal received from the base station, and selects a codeword corresponding to the estimated channel and then notifies the base station of the channel status by feeding index for the selected codeword back to the base station. If the base station performs beamforming by using each column vector of the codebook as a beamforming vector, the user equipment calculates quality of a downlink channel and generates a downlink channel quality indicator. Next, the user equipment feeds a position of a column vector corresponding to the most excellent downlink channel quality indicator and a downlink channel quality indicator based on the position of the column vector back to the base station.

An example of a beamforming method based on a codebook may include a zero forcing beamforming (ZFBF) scheme. The ZFBF scheme selects a quantization vector, which is the most similar to the channel estimated from the reference signal by the user equipment, from the codebook, and then transmits the selected quantization vector. For convenience of description, the ith quantization vector in the codebook is defined as q, regardless of rank, whereby the quantization vector may be selected by the following Equation 1.

q*=arg max |Hₖqᵢ] [Equation 1]

In this case, arg max f(x) represents a value of x that allows f(x) to have a maximum value. Hₖ represents a channel vector of the kth user equipment. Each user equipment transmits the most quantization vector index to the base station through the aforementioned procedure. The base station selects user equipments by using the received quantization vector index to provide the selected user equipments with a service. At this time, if the base station selects M number of user equipments to provide the selected user equipment with a service (that is, 1≦k≦M), a weight vector of the ZFBF scheme may be expressed as follows.

W=[(q₁, . . . q_{M})⁻]⁻¹=[w₁ . . . w_{M}] [Equation 2]

In this case, if a set of the selected quantization vectors is not a square matrix, pseudo inverse operation is used. Accordingly, normalized columns of a matrix W become ZFBF weight vectors of the kth user equipment.

### SUMMARY OF THE INVENTION

Accordingly, the present invention is directed to a method and apparatus for receiving a signal in a wireless communication system, which substantially obviate one or more problems due to limitations and disadvantages of the related art.

An object of the present invention is to provide a method and apparatus for receiving a signal in a wireless communication system, which supports MU-MIMO scheme, to maximize a signal-to-interference plus noise ratio (SINR) for a received signal.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for receiving a signal through a user equipment in a wireless communication system, which supports multi-user-MIMO (MU-MIMO) scheme, comprises the steps of calculating a channel matrix on the basis of a reference signal included in a signal received from a base station; calculating a first vector having maximum channel gain in a vector space formed by the channel matrix; determining a second vector, which minimizes a quantization error with the channel matrix, by using a precoding codebook; calculating a third vector located between the first vector and the second vector, indicating an effective channel having a maximum signal-to-interference plus noise ratio (SINR) for the received signal; and processing the received signal by using a received weight vector determined on the basis of the third vector.

In another aspect of the present invention, a user equipment for receiving a signal in a wireless communication system, which supports multi-user-MIMO (MU-MIMO) scheme, comprises a radio frequency (RF) unit; and a processor, wherein the processor is configured to calculate a channel matrix on the basis of a reference signal included in a signal received from a base station, calculate a first vector having maximum channel gain in a vector space formed by the channel matrix, determine a second vector, which minimizes a quantization error with the channel matrix, by using a precoding codebook, calculate a third vector located between the first vector and the second vector, indicating an effective channel having a maximum signal-to-interference plus noise ratio (SINR) for the received signal, and process the received signal by using a received weight vector determined on the basis of the third vector.

The following matters may commonly be applied to the embodiments of the present invention.

The SINR may be expressed by the following Equation A:

$${SINR}_{k} \approx \frac{{p}_{k} {‖ {h}_{k} ‖}^{2} {cos}^{2} {θ}_{k}}{1 + {p}_{k} {‖ {h}_{k} ‖}^{2} {sin}^{2} {θ}_{k}} \qquad [ Equation A ]$$

where, pₖ represents a power of the received signal, θₖ represents an angle between the first vector and the third vector, and hₖ represents a vector for the effective channel.

The first vector may be a vector corresponding to the greatest singular vector in a matrix Vₖ if the channel matrix is decomposed as expressed by the following Equation B in accordance with a singular value decomposition (SVD) scheme:

Hₖ=UₖSₖVₖ^{H} [Equation 8]

where, Hₖ represents the channel matrix, the matrix Uₖ is orthogonal to the matrix Vₖ, and the matrix Sₖ represents a diagonal matrix having a singular value.

The first vector may be expressed by the following Equation C:

$${v}_{1}^{k} \approx \frac{{H}_{k}^{H} {\tilde{u}}^{*}}{‖ {H}_{k}^{H} {\tilde{u}}^{*} ‖} \qquad [ Equation C ]$$

where, v₁^{k} represents the first vector, Hₖ represents the channel matrix, and the following Equation D is satisfied:

$${\tilde{u}}^{*} = {max}_{{\tilde{u}}_{i}} ‖ {H}_{k}^{H} {\tilde{u}}_{i} ‖ \qquad [ Equation D ]$$

where, ũᵢ represents a quantization vector based on a precoding codebook.

The second vector may be expressed by the following Equation E if the number of antennas of the base station is more than that of the user equipment:

$${\hat{h}}_{k} = arg {max}_{q} \frac{{p}_{k} {\vert {q}^{H} \overline{q} \vert}^{2} / {\sum }_{j = 1}^{r} {( \frac{cos {φ}_{j}}{{λ}_{j}^{k}} )}^{2}}{1 + {{p}_{k} ( 1 - \vert {q}^{H} \overline{q} \vert )}^{2} / {\sum }_{j = 1}^{r} {( \frac{cos {φ}_{j}}{{λ}_{j}^{k}} )}^{2}} \qquad [ Equation E ]$$

where, ĥₖ represents the second vector, pₖ represents a power of the received signal, a vector q represents a quantization vector based on the precoding codebook, a vector q̅ represents the quantization vector projected to the channel matrix, λⱼ^{k} represents a singular value corresponding to the jth right-singular vector of the channel matrix, φⱼ represents an angle between the quantization vector and the right-singular vector, and r represents a rank of the channel matrix.

The second vector may be expressed by the following Equation F if the number of antennas of the base station is less than or equal to that of the user equipment:

$${\hat{h}}_{k} = arg {max}_{q} 1 / {\sum }_{j = 1}^{r} {( \frac{cos {φ}_{j}}{{λ}_{j}^{k}} )}^{2} \qquad [ Equation F ]$$

where, \tilde{h}ₖ represents the second vector, a vector q represents a quantization vector based on the precoding codebook, λⱼ^{k} represents a singular value corresponding to the jth right-singular vector of the channel matrix, φⱼ represents an angle between the quantization vector and the right-singular vector, and r represents a rank of the channel matrix.

The angle between the first vector and the third vector may be expressed by the following Equation G if the number of antennas of the base station is less than or equal to that of the user equipment:

$${φ}_{1}^{{k}^{*}} = arg {max}_{{φ}_{1}^{k}} \frac{\begin{matrix}{p}_{k} [ \begin{matrix}1 / {\sum }_{j = 1}^{r} {( \frac{1}{{λ}_{j}} )}^{2} \\ \vert {( {v}_{j}^{k} )}^{H} {( cos {φ}_{1}^{k} {v}_{1}^{k} + sin {φ}_{1}^{k} {v}_{⊥} )}^{2} \vert\end{matrix} ] \\ {cos}^{2} ( {ϕ}_{k} - {φ}_{1}^{k} )\end{matrix}}{\begin{matrix}1 + {p}_{k} [ \begin{matrix}1 / {\sum }_{j = 1}^{r} {( \frac{1}{{λ}_{j}} )}^{2} \\ \vert {( {v}_{j}^{k} )}^{H} {( cos {φ}_{1}^{k} {v}_{1}^{k} + sin {φ}_{1}^{k} {v}_{⊥} )}^{2} \vert\end{matrix} ] \\ {sin}^{2} ( {ϕ}_{k} - {φ}_{1}^{k} )\end{matrix}} \qquad [ Equation G ]$$

where, Ø₁^{k}* represents the angle between the first vector and the third vector, pₖ represents a power of the received signal, vⱼ^{k} represents the jth right-singular vector of the channel matrix, λⱼ represents a singular value corresponding to the right-singular vector, φₖ represents an angle between the first vector and the second vector, Ø₁^{k} represents the angle between the first vector and the third vector, and v₁^{k} and v_{⊥} represent that a unit effective channel vector is decomposed.

The angle between the first vector and the third vector may be expressed by the following Equation H if the number of antennas of the base station is more than that of the user equipment:

$${φ}_{1}^{{k}^{*}} = arg {max}_{{φ}_{1}^{k}} \frac{\begin{matrix}{p}_{k} [ 1 / {\sum }_{j = 1}^{r} {( \frac{1}{{λ}_{j}} )}^{2} \vert {( {v}_{j}^{k} )}^{H} {( cos {φ}_{1}^{k} {v}_{1}^{k} + sin {φ}_{1}^{k} {\overline{v}}_{⊥} )}^{2} \vert ] \\ {‖ {q}_{proj} ‖}^{2} {cos}^{2} ( {ϕ}_{k} - {φ}_{1}^{k} )\end{matrix}}{\begin{matrix}1 + {p}_{k} [ 1 / {\sum }_{j = 1}^{r} {( \frac{1}{{λ}_{j}} )}^{2} \vert {( {v}_{j}^{k} )}^{H} {( cos {φ}_{1}^{k} {v}_{1}^{k} + sin {φ}_{1}^{k} {\overline{v}}_{⊥} )}^{2} \vert ] \\ ( 1 - {‖ {q}_{proj} ‖}^{2} {cos}^{2} ( {ϕ}_{k} - {φ}_{1}^{k} ) )\end{matrix}} \qquad [ Equation H ]$$

where, Ø₁^{k}* represents the angle between the first vector and the third vector, pₖ represents a power of the received signal, vⱼ^{k} represents the jth right-singular vector of the channel matrix, λⱼ represents a singular value corresponding to the right-singular vector, φₖ represents an angle between the first vector and the second vector, Ø₁^{k} represents the angle between the first vector and the third vector, and v₁^{k} and V̅_{⊥} represent that a unit effective channel vector is decomposed.

The received weight vector may be expressed by the following Equation I:

$${u}_{k} = \frac{{( {H}_{k}^{H} )}^{†} {h}_{k}^{*}}{‖ {( {H}_{k}^{H} )}^{†} {h}_{k}^{*} ‖} \qquad [ Equation I ]$$

where, uₖ represents the received weight vector, Hₖ represents the channel matrix, and hₖ*represents the third vector.

The aforementioned embodiments and the following detailed description of the present invention are only exemplary, and are for additional description of the present invention cited in claims.

According to the aforementioned embodiments of the present invention, the method and apparatus for receiving a signal in a wireless communication system, which supports MU-MIMO scheme, to maximize a signal-to-interference plus noise ratio (SINR) for a received signal may be provided.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating a structure of a downlink radio frame;

FIG. 2 is a diagram illustrating an example of a resource grid for one downlink slot;

FIG. 3 is a diagram illustrating a structure of a downlink subframe;

FIG. 4 is a diagram illustrating a structure of an uplink subframe;

FIG. 5 is a schematic diagram illustrating a wireless communication system having multiple antennas;

FIG. 6 is a diagram illustrating a pattern of CRS and DRS according to the related art;

FIG. 7 is a diagram illustrating an example of a DM RS pattern;

FIG. 8 is a diagram illustrating examples of a CSI-RS pattern;

FIG. 9 is a flow chart illustrating a method for receiving a signal in accordance with the present invention;

FIG. 10 is a diagram illustrating an example of a method for calculating a third vector in accordance with the present invention;

FIG. 11 is a diagram illustrating a third vector when the number of antennas of a base station is smaller than or equal to the number of antennas of a user equipment;

FIG. 12 is a diagram illustrating a third vector when the number of antennas of a base station is greater than the number of antennas of a user equipment; and

FIG. 13 is a diagram illustrating a base station and a user equipment that may be applied to one embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The following embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment.

In this specification, the embodiments of the present invention have been described based on data transmission and reception between a base station and a user equipment. In this case, the base station means a terminal node of a network, which performs direct communication with the user equipment. A specific operation which has been described as being performed by the base station may be performed by an upper node of the base station as the case may be.

In other words, it will be apparent that various operations performed for communication with the user equipment in the network which includes a plurality of network nodes along with the base station may be performed by the base station or network nodes other than the base station. The base station (BS) may be replaced with terms such as a fixed station, Node B, eNode B (eNB), and an access point (AP). Also, in this specification, the term, base station may be used as a concept that includes a cell or sector. For example, in the present invention, a serving base station may be referred to as a serving cell and a cooperative base station may be referred to as a cooperative cell. Also, a terminal may be replaced with terms such as a user equipment (UE), a mobile station (MS), a mobile subscriber station (MSS), or a subscriber station (SS).

Specific terminologies hereinafter used in the embodiments of the present invention are provided to assist understanding of the present invention, and various modifications may be made in the specific terminologies within the range that they do not depart from technical spirits of the present invention.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

The embodiments of the present invention may be supported by standard documents disclosed in at least one of wireless access systems, i.e., IEEE 802 system, 3GPP system, 3GPP LTE system, 3GPP LTE and LTE-A (LTE-Advanced) system, and 3GPP2 system. Namely, among the embodiments of the present invention, apparent steps or parts, which are not described to clarify technical spirits of the present invention, may be supported by the above documents. Also, all terminologies disclosed herein may be described by the above standard documents.

The following technology may be used for various wireless access systems such as code division multiple access (CDMA), frequency division multiple access (FDMA), time division multiplex access (TDMA), orthogonal frequency division multiple access (OFDMA), and single carrier frequency division multiple access (SC-FDMA). The CDMA may be implemented by the radio technology such as universal terrestrial radio access (UTRA) or CDMA2000. The TDMA may be implemented by the radio technology such as global system for mobile communications (GSM)/general packet radio service (GPRS)/enhanced data rates for GSM evolution (EDGE). The OFDMA may be implemented by radio technology such as IEEE 802.11 (Wi-Fi), IEEE 802.16 (WiMAX), IEEE 802.20, and evolved UTRA (E-UTRA). The UTRA is a part of a universal mobile telecommunications system (UMTS). A 3rd generation partnership project long term evolution (3GPP LTE) communication system is a part of an evolved UMTS (E-UMTS) that uses E-UTRA, and uses OFDMA on a downlink and SC-FDMA on an uplink. LTE-advanced (LTE-A) is an evolved version of the 3GPP LTE. WiMAX may be described by the IEEE 802.16e standard (WirelessMAN-OFDMA Reference System) and the advanced IEEE 802.16m standard (WirelessMAN-OFDMA Advanced system). Although the following description will be based on the 3GPP LTE system and the 3GPP LTE-A system to clarify description, it is to be understood that technical spirits of the present invention are not limited to the 3GPP LTE and the 3GPP LTE-A system.

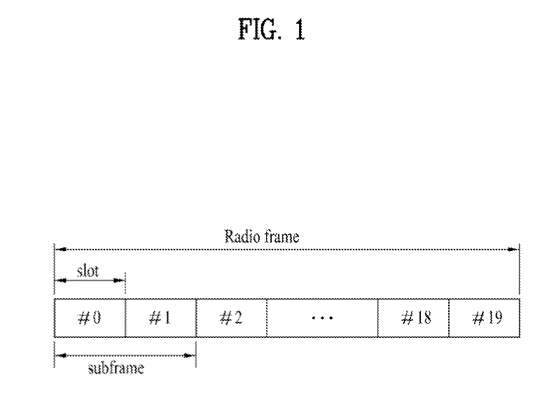

A structure of a downlink radio frame will be described with reference to FIG. 1.

In a cellular OFDM wireless packet communication system, uplink/downlink data packet transmission is performed in a subframe unit, wherein one subframe is defined by a given time interval that includes a plurality of OFDM symbols. The 3GPP LTE standard supports a type 1 radio frame structure applicable to frequency division duplex (FDD) and a type 2 radio frame structure applicable to time division duplex (TDD).

FIG. 1 is a diagram illustrating a structure of a type 1 radio frame. The downlink radio frame includes 10 subframes, each of which includes two slots in a time domain. A time required to transmit one subframe will be referred to as a transmission time interval (TTI). For example, one subframe may have a length of 1 ms, and one slot may have a length of 0.5 ms. One slot includes a plurality of OFDM symbols in a time domain and a plurality of resource blocks (RB) in a frequency domain. Since OFDMA is used on the downlink in the 3GPP LTE system, OFDM symbols represent one symbol interval. The OFDM symbols may be referred to as SC-FDMA symbols or symbol interval. The resource block (RB) is a resource allocation unit, and one slot may include a plurality of continuous subcarriers.

The number of OFDM symbols included in one slot may be varied depending on configuration of cyclic prefix (CP). Examples of the CP include extended CP and normal CP. For example, if the OFDM symbols are configured by normal CP, the number of OFDM symbols included in one slot may be 7. If the OFDM symbols are configured by extended CP, since the length of one OFDM symbol is increased, the number of OFDM symbols included in one slot is smaller than that of OFDM symbols in case of normal CP. In case of the extended CP, the number of OFDM symbols included in one slot may be 6. If a channel status is unstable like the case where the user equipment moves at high speed, the extended CP may be used to reduce inter-symbol interference.

If the normal CP is used, since one slot includes seven OFDM symbols, one subframe includes 14 OFDM symbols. At this time, first two or three OFDM symbols of each subframe may be allocated to a physical downlink control channel (PDCCH), and the other OFDM symbols may be allocated to a physical downlink shared channel (PDSCH).

The structure of the radio frame is only exemplary, and various modifications may be made in the number of subframes included in the radio frame, the number of slots included in the subframe, or the number of symbols included in the slot.

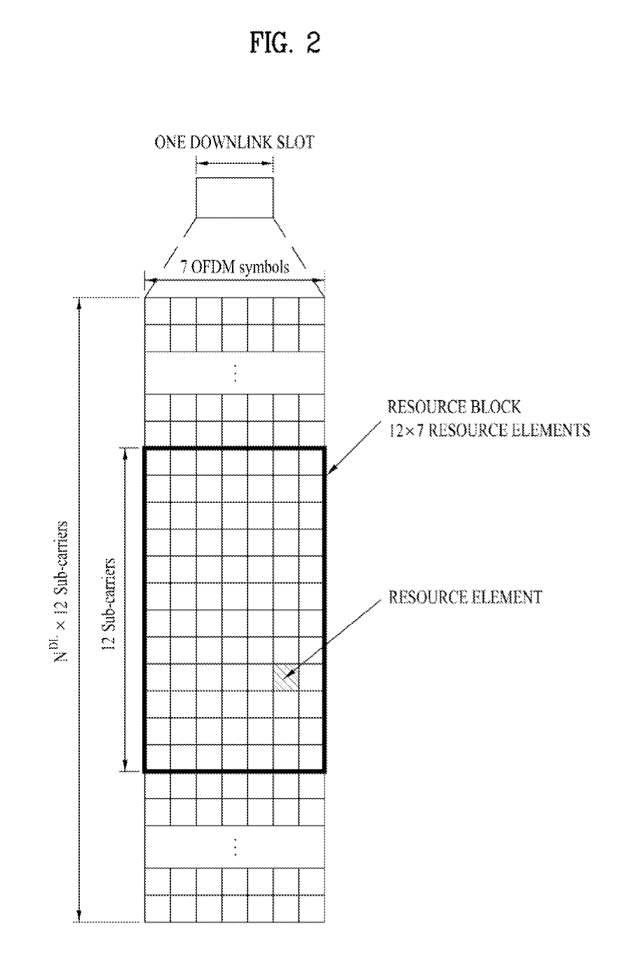

FIG. 2 is a diagram illustrating an example of a resource grid for a downlink slot. In this case, OFDM symbols are configured by a normal CP. Referring to FIG. 2, a downlink slot includes a plurality of OFDM symbols in a time domain and a plurality of resource blocks in a frequency domain. In this case, one downlink slot includes, but not limited to, seven OFDM symbols, and one resource block (RB) includes, but not limited to, twelve subcarriers. Each element on the resource grid will be referred to as a resource element (RE). For example, resource element a(k, l) becomes the resource element located at the kth subcarrier and the first OFDM symbol. In case of the normal CP, one resource block includes 12×7 resource elements (in case of the extended CP, one resource block includes 12×6 resource elements). Since an interval between the respective subcarriers is 15 kHz, one resource block includes 180 kHz, approximately, in the frequency domain. N^{DL} is the number of resource blocks included in the downlink slot. The value of N^{DL} may be determined depending on a downlink transmission bandwidth set by scheduling of the base station.

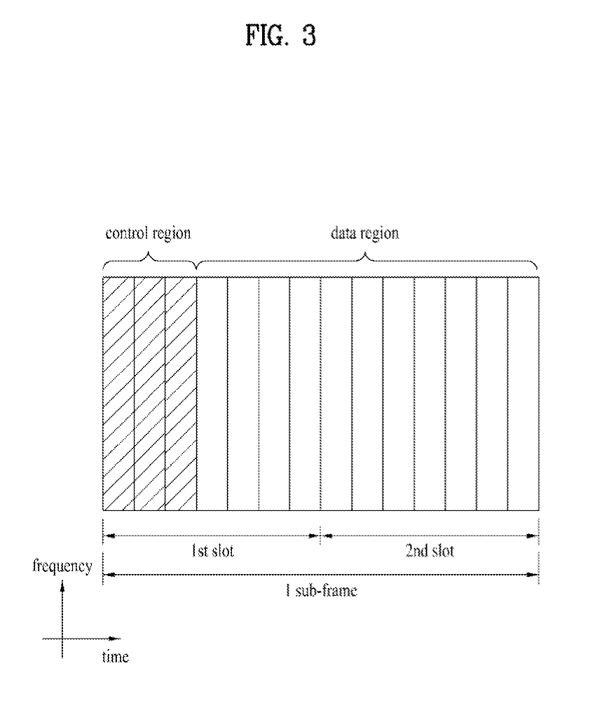

FIG. 3 is a diagram illustrating a structure of a downlink subframe. Maximum three OFDM symbols located at the front of the first slot within one subframe correspond to a control region to which a control channel is allocated. The other OFDM symbols correspond to a data region to which a physical downlink shared channel (PDSCH) is allocated. A basic unit of transmission becomes one subframe. In other words, a PDCCH and a PDSCH are allocated to two slots. Examples of downlink control channels used in the 3GPP LTE system include a Physical Control Format Indicator Channel (PCFICH), a Physical Downlink Control Channel (PDCCH), and a Physical Hybrid ARQ Indicator Channel (PHICH). The PCFICH is transmitted from the first OFDM symbol of the subframe, and includes information on the number of OFDM symbols used for transmission of the control channel within the subframe. The PHICH includes HARQ ACK/NACK signal in response to uplink transmission. The control information transmitted through the PDCCH will be referred to as downlink control information (DCI). The DCI includes uplink or downlink scheduling information, or uplink transmission (Tx) power control command for a random user equipment group. The PDCCH may include transport format and resource allocation information of a downlink shared channel (DL-SCH), resource allocation information of an uplink shared channel (UL-SCH), paging information on a paging channel (PCH), system information on the DL-SCH, resource allocation information of upper layer control message such as random access response transmitted on the PDSCH, a set of transmission power control commands of individual user equipments (UEs) within a random user equipment group, transmission power control information, and activity information of voice over Internet protocol (VoIP). A plurality of PDCCHs may be transmitted within the control region. The user equipment may monitor the plurality of PDCCHs. The PDCCH is transmitted by aggregation of one or more continuous control channel elements (CCEs). The CCE is a logic allocation unit used to provide the PDCCH at a coding rate based on the status of a radio channel. The CCE corresponds to a plurality of resource element groups (REGs). The format of the PDCCH and the number of available bits of the PDCCH are determined depending on the correlation between the number of CCEs and a coding rate provided by the CCE. The base station determines a PDCCH format depending on the DCI transmitted to the user equipment, and attaches cyclic redundancy check (CRC) to the control information. The CRC is masked with an identifier (for example, radio network temporary identifier (RNTI)) depending on owner or usage of the PDCCH. If the PDCCH is for a specific user equipment, the CRC may be masked with cell-RNTI (C-RNTI) of the corresponding user equipment. If the PDCCH is for a paging message, the CRC may be masked with a paging indicator identifier (P-RNTI). If the PDCCH is for system information (in more detail, system information block (SIB)), the CRC may be masked with system information identifier and system information RNTI (SI-RNTI). In order to represent a random access response which is the response to transmission of a random access preamble of the user equipment, the CRC may be masked with a random access RNTI (RA-RNTI).

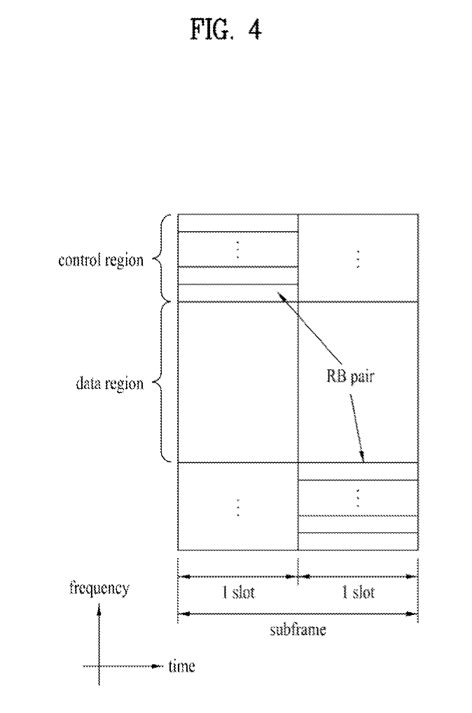

FIG. 4 is a diagram illustrating a structure of an uplink subframe. The uplink subframe may be divided into a control region and a data region in a frequency domain. A physical uplink control channel (PUCCH) which includes uplink control information is allocated to the control region. A physical uplink shared channel (PUSCH) which includes user data is allocated to the data region. In order to maintain single carrier properties, one user equipment does not transmit the PUCCH and the PUSCH at the same time. The PUCCH for one user equipment is allocated to a pair of RBs at the subframe. Resource blocks belonging to the pair of RBs occupy different subcarriers for two slots. This will be referred to frequency hopping of a pair of RBs allocated to the PUCCH at the boundary of the slots.

Modeling of MIMO System

MIMO (Multiple Input Multiple Output) system is a system that improves efficiency in data transmission and reception by using multiple transmitting antennas and multiple receiving antennas. The MIMO technology may receive full data by combining a plurality of data fragments received through a plurality of antennas without depending on a single antenna path.

Examples of the MIMO technology include a spatial diversity scheme and a spatial multiplexing scheme. Since the spatial diversity scheme may increase transmission reliability or a cell radius through diversity gain, it is suitable for data transmission to a user equipment which moves at high speed. The spatial multiplexing scheme allows different data to be transmitted at the same time, whereby a data transmission rate may be increased without increase of a system bandwidth.

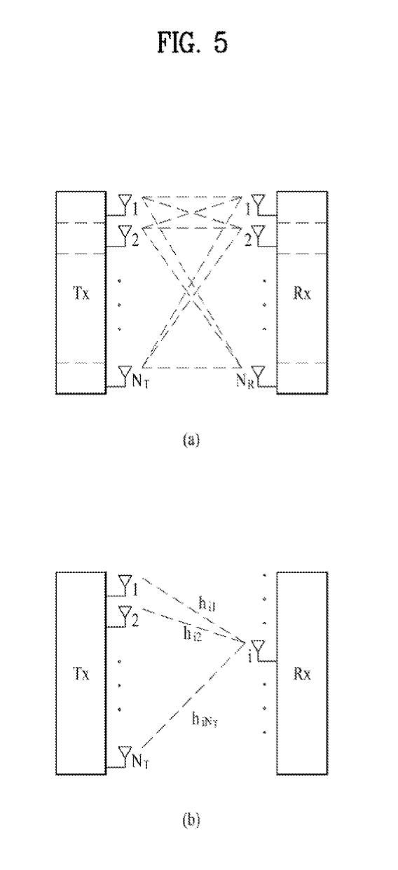

FIG. 5 is a schematic view illustrating a wireless communication system provided with multiple antennas. As shown in FIG. 5(a), if the number of transmitting antennas is increased to N_{T} and the number of receiving antennas is increased to N_{R}, channel transmission capacity is increased theoretically in proportion to the number of antennas unlike that a plurality of antennas are used in only a transmitter or receiver. Accordingly, it is possible to improve a transmission rate and remarkably improve frequency efficiency. A transmission rate based on increase of channel transmission capacity may increase theoretically as much as a value obtained by multiplying a maximum transmission rate R₀, which corresponds to a case where one antenna is used, by an increase rate Rᵢ, as follows.

R₁=min (N_{T}, N_{R}) [Equation 3]

For example, in a MIMO communication system that uses four transmitting antennas and four receiving antennas, a transmission rate theoretically four times greater than that of a single antenna system may be obtained. After theoretical capacity increase of the MIMO system has been proved in the middle of 1990, various technologies have been actively studied to substantially improve a data transmission rate. Some of the technologies have been already reflected in the standard of various wireless communications such as third generation mobile communication and next generation wireless LAN.

Upon reviewing the recent trend of studies related to the MIMO system, active studies are ongoing in view of various aspects such as the study of information theoretical aspect related to MIMO communication capacity calculation under various channel environments and multiple access environments, the study of radio channel measurement and modeling of a MIMO system, and the study of time space signal processing technology for improvement of transmission reliability and transmission rate.

A communication method in a MIMO system will be described in more detail with reference to mathematical modeling. In the MIMO system, it is assumed that N_{T} transmitting antennas and N_{R} receiving antennas exist.

First of all, a transmitting signal will be described. If there exist N_{T} transmitting antennas, the number of maximum transmission information is N_{T}. The transmission information may be expressed as follows.

s=└s₁, s₂, . . . s_{N}_{_{T}}┘^{T} [Equation 4]

Different kinds of transmission power may be applied to each of the transmission information s₁, s₂, . . . , s_{N}_{_{T}}. At this time, supposing that each transmission power is P₁, P₂, . . . , P_{M}_{_{T}}, transmission information of which transmission power is controlled may be expressed as follows.

ŝ=[ŝ₁, ŝ₂, . . . , ŝ_{N}_{_{T}}]^{T}=[P₁s₁, P₂s₂, . . . , P_{N}_{_{T}}s_{N}_{_{T}}]^{T} [Equation 5]

Also, Ŝ may be expressed as follows using a diagonal matrix P.

$$\hat{s} = [ \begin{matrix}{P}_{1} & & & 0 \\ & {P}_{2} & & \\ & & ⋱ & \\ 0 & & & {P}_{{N}_{T}}\end{matrix} ] [ \begin{matrix}{s}_{1} \\ {s}_{2} \\ ⋮ \\ {s}_{{N}_{T}}\end{matrix} ] = Ps \qquad [ Equation 6 ]$$

It is considered that a weight matrix W is applied to the information vector Ŝ of which transmission power is controlled, so as to obtain N_{T} transmitting signals x₁, x₂, . . . x_{N}_{_{T}}. In this case, the weight matrix W serves to properly distribute the transmission information to each antenna. Such transmitting signals x₁, x₂, . . . x_{N}_{_{T}} may be expressed as follows using a vector X.

$$\begin{matrix}x = [ \begin{matrix}{x}_{1} \\ {x}_{2} \\ ⋮ \\ {x}_{i} \\ ⋮ \\ {x}_{{N}_{T}}\end{matrix} ] \\ = [ \begin{matrix}{w}_{11} & {w}_{12} & … & {w}_{1 {N}_{T}} \\ {w}_{21} & {w}_{22} & … & {w}_{2 {N}_{T}} \\ ⋮ & & ⋱ & \\ {w}_{i 1} & {w}_{i 2} & … & {w}_{{iN}_{T}} \\ ⋮ & & ⋱ & \\ {w}_{{N}_{T} 1} & {w}_{{N}_{T} 2} & … & {w}_{{N}_{T} {N}_{T}}\end{matrix} ] [ \begin{matrix}{\hat{s}}_{1} \\ {\hat{s}}_{2} \\ ⋮ \\ {\hat{s}}_{i} \\ ⋮ \\ {\hat{s}}_{{N}_{T}}\end{matrix} ] \\ = W \hat{s} \\ = WPs\end{matrix} \qquad [ Equation 7 ]$$

In this case, Wᵢⱼ means a weight value between the ith transmitting antenna and the jth information. W may be referred to as a precoding matrix.

In the meantime, the transmitting signals x may be considered by two methods depending on two cases (for example, spatial diversity and spatial multiplexing). In case of spatial multiplexing, different signals are multiplexed and the multiplexed signals are transmitted to a receiver, whereby elements of information vectors have different values. Meanwhile, in case of spatial diversity, the same signal is repeatedly transmitted through a plurality of channel paths, whereby elements of information vectors have the same value. A hybrid scheme of the spatial multiplexing and the spatial diversity scheme may be considered. In other words, the same signal may be transmitted through three transmitting antennas in accordance with the spatial diversity scheme, and the other signals may be transmitted to the receiver through spatial multiplexing.

If there exist N_{R} receiving antennas, receiving signals y₁, y₂, . . . y_{N}_{_{R}} of the respective antennas may be expressed by a vector as follows.

y=[y₁, y₂, . . . , y_{N}_{_{R}}]^{T} [Equation 4]

In case of channel modeling in the MIMO communication system, channels may be classified depending on indexes of transmitting and receiving antennas. In this case, a channel that passes from the jth transmitting antenna to the ith receiving antenna will be expressed as hᵢⱼ. It is noted that index of the receiving antenna is prior to index of the transmitting antenna in index of hᵢⱼ.

FIG. 5(b) illustrates channels from N_{T} transmitting antennas from the receiving antenna i. Several channels may be grouped into one and then may be expressed by a vector type or a matrix type. As shown in FIG. 5(b), the channels from N_{T} transmitting antennas to the ith receiving antenna may be expressed as follows.

hᵢ^{T}=└hᵢ₁, hᵢ₂, . . . , h_{1N}_{_{T}}┘ [Equation 9]

Accordingly, all channels from N_{T} transmitting antennas to N_{R} receiving antennas may be expressed as follows.

$$H = [ \begin{matrix}{h}_{1}^{T} \\ {h}_{2}^{T} \\ ⋮ \\ {h}_{i}^{T} \\ ⋮ \\ {h}_{{N}_{R}}^{T}\end{matrix} ] = [ \begin{matrix}{h}_{11} & {h}_{12} & … & {h}_{1 {N}_{T}} \\ {h}_{21} & {h}_{22} & … & {h}_{2 {N}_{T}} \\ ⋮ & & ⋱ & \\ {h}_{i 1} & {h}_{i 2} & … & {h}_{{iN}_{T}} \\ ⋮ & & ⋱ & \\ {h}_{{N}_{R} 1} & {h}_{{N}_{R} 2} & … & {h}_{{N}_{R} {N}_{T}}\end{matrix} ] \qquad [ Equation 10 ]$$

Since additive white Gaussian noise (AWGN) is actually added to the channels after the above channel matrix H. AWGN n₁, n₂, . . . , n_{N}_{ₖ} added to each of the N_{R} receiving antennas may be expressed as follows.

n=[n₁, n₂, . . . , n_{N}_{ₖ}]^{T} [Equation 11]

The receiving signals obtained using the above equation modeling may be expressed as follows.

$$y = [ \begin{matrix}{y}_{1} \\ {y}_{2} \\ ⋮ \\ {y}_{i} \\ ⋮ \\ {y}_{{N}_{R}}\end{matrix} ] = [ \begin{matrix}{h}_{11} & {h}_{12} & … & {h}_{1 {N}_{T}} \\ {h}_{21} & {h}_{22} & … & {h}_{2 {N}_{T}} \\ ⋮ & & ⋱ & \\ {h}_{i 1} & {h}_{i 2} & … & {h}_{{iN}_{T}} \\ ⋮ & & ⋱ & \\ {h}_{{N}_{R} 1} & {h}_{{N}_{R} 2} & … & {h}_{{N}_{R} {N}_{T}}\end{matrix} ] [ \begin{matrix}{x}_{1} \\ {x}_{2} \\ ⋮ \\ {x}_{j} \\ ⋮ \\ {x}_{{N}_{T}}\end{matrix} ] + [ \begin{matrix}{n}_{1} \\ {n}_{2} \\ ⋮ \\ {n}_{i} \\ ⋮ \\ {n}_{{N}_{R}}\end{matrix} ] = Hx + n \qquad [ Equation 12 ]$$

The number of rows and columns of the channel matrix H indicating the channel status is determined by the number of transmitting antennas and the number of receiving antennas. The number of rows in the channel matrix H is the same as the number N_{R} of receiving antennas, and the number of columns is the same as the number N_{T} of transmitting antennas. In other words, the channel matrix H may be expressed by N_{R} N_{T} matrix.

A rank of the matrix is defined by a minimum number of the number of rows and the number of columns, which are independent from each other. Therefore, the rank of the matrix cannot have a value greater than the number of rows or the number of columns. Rank (rank(H) of the channel matrix H may be limited as follows.

rank(H)≦min(N_{T}, N_{R}) [Equation 13]

In MIMO transmission, ‘Rank’ represents the number of paths that may independently transmit a signal from a specific frequency resource at a specific time, and ‘the number of layers’ represents the number of signal streams transmitted through each path. Generally, since the transmitter transmits layers corresponding to the number of ranks, the ranks are the same as the number of layers unless mentioned otherwise.

Reference Signal (RS)

In the wireless communication system, since a packet is transmitted through a radio channel, signal distortion may occur during transmission of the packet. In order to normally receive the distorted signal, distortion of the received signal should be compensated using channel information. In order to discover the channel information, it is required to transmit the signal known by both a transmitter and a receiver and discover the channel information using a distortion level of the signal when the signal is transmitted through the channel. In this case, the signal known by both the transmitter and the receiver will be referred to as a pilot signal or a reference signal.

In case that multiple antennas are used to transmit and receive data, a channel status between each transmitting antenna and each receiving antenna should be known to receive a normal signal. Accordingly, a separate reference signal per transmitting antenna should be provided.

In the wireless communication system, the reference signal (RS) may be divided into two types. Namely, examples of the reference signal include a reference signal (RS) used for acquisition of channel information and a reference signal (RS) used for data demodulation. Since the former RS is intended for acquisition of channel information on the downlink through the user equpment, it needs to be transmitted through a wideband. Also, the former RS should be received and measured even by a user equipment that does not receive downlink data for a specific subframe. Also, this RS may be used for measurement of handover. The latter RS is transmitted from the base station together with a corresponding resource when the base station transmits downlink data. In this case, the user equipment may perform channel estimation by receiving the corresponding RS, whereby the user equipment may demodulate the data. This RS should be transmitted to a region to which data are transmitted.

In the existing 3GPP LTE (for example, 3GPP LTE release-8) system, two types of downlink reference signals are defined for unicast service. One of the reference signals is a common reference signal (CRS) and the other one is a dedicated RS (DRS). The CRS is used for acquisition of channel status information and measurement of handover and may be referred to as a cell-specific RS. The DRS is used for data demodulation, and may be referred to as a user equipment-specific RS. In the existing 3GPP LTE system, the DRS is only used for data demodulation, and the CRS is used for both acquisition of channel information and data demodulation.

The CRS is a cell-specifically transmitted reference signal, and is transmitted per subframe through a wideband. The CRS may be transmitted for maximum four antenna ports depending on the number of transmitting antennas of the base station. For example, if the number of transmitting antennas of the base station is two, the CRS for the antenna ports 0 and 1 are transmitted. If the number of transmitting antennas is four, the CRS for the antenna ports 0 to 3 are transmitted.

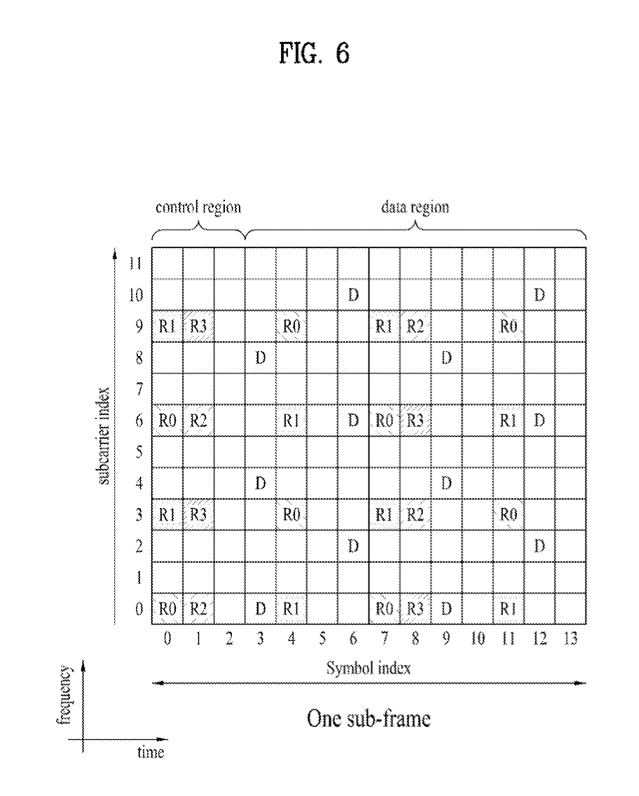

FIG. 6 is a diagram illustrating a pattern of CRS and DRS on one resource block (in case of normal CP, 14 OFDM symbols on the time×12 subcarriers on the frequency) in a system that supports four transmitting antennas by means of a base station. In FIG. 6, resource elements (REs) ‘R0’, ‘R1’, ‘R2’ and ‘R3’ represent positions of CRS for the antenna ports 0, 1, 2 and 3. Meanwhile, in FIG. 6, a resource element ‘ID’ represents a position of DRs defined in the LTE system.

The LTE-A system which is an evolved version of the LTE system may support maximum eight transmitting antennas for downlink transmission. Accordingly, reference signals for maximum eight transmitting antennas should also be supported. In the LTE system, since downlink reference signals are defined for maximum four antenna ports, if the base station includes maximum eight downlink transmitting antennas in the LTE-A system, reference signals for these antenna ports should be defined additionally. The reference signals for maximum eight transmitting antenna ports should be considered for two types of reference signals, i.e., reference signal for channel measurement and reference signal for data demodulation.

One of important considerations in designing the LTE-A system is backward compatibility. Backward compatibility means that the LTE user equipment should be operated normally even in the LTE-A system without any problem. In view of reference signal transmission, if reference signals for maximum eight transmitting antenna ports should be defined additionally in the time-frequency domain to which CRS defined in the LTE standard is transmitted to a full band, RS overhead becomes too great. Accordingly, it should be considered that RS overhead is reduced in newly designing RS for maximum eight antenna ports.

The reference signal designed newly in the LTE-A system may be divided into two types. One of the reference signals is a channel status information-reference signal (CSI-RS) which is for channel measurement for selection of transmission rank, modulation and coding scheme (MCS) and precoding matrix index (PMI), and the other one is a demodulation-reference signal (DM-RS) for demodulation of data transmitted through maximum eight transmitting antennas.

The CSI-RS for channel measurement is designed for channel measurement mainly unlike the existing CRS used for channel measurement, handover measurement, and data demodulation. The CSI-RS may also be used for handover measurement. Since the CSI-RS is transmitted only to obtain channel status information, it may not be transmitted per subframe unlike the CRS of the existing LTE system. Accordingly, in order to reduce overhead of the CSI-RS, the CSI-RS may be designed to be intermittently (for example, periodically) be transmitted on the time axis.

If data are transmitted on a downlink subframe, a dedicated DM RS is transmitted to a user equipment scheduled for data transmission. DM RS dedicated for a specific user equipment may be designed to be transmitted only in a resource region where the corresponding user equipment is scheduled, that is, a time-frequency domain to which data of the corresponding user equipment are transmitted.

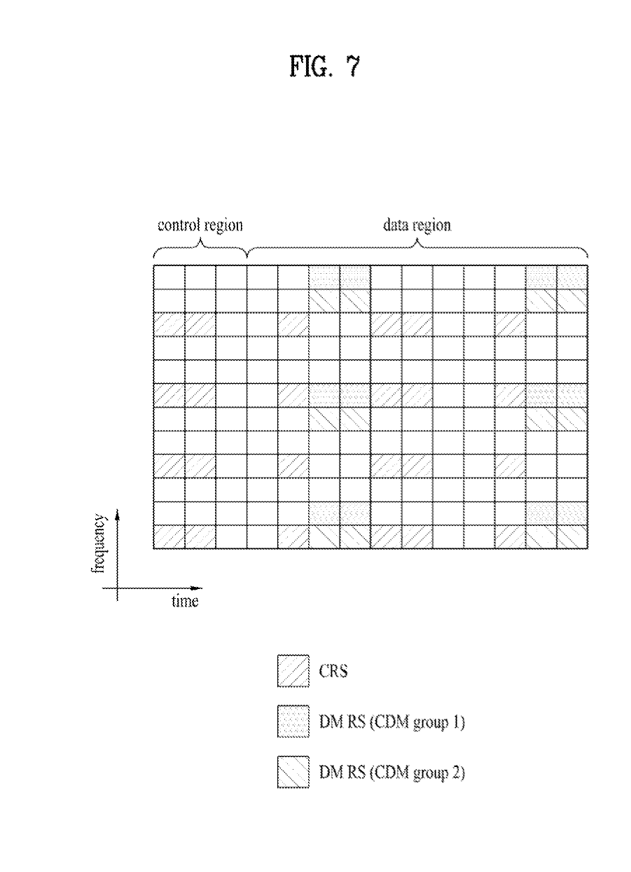

FIG. 7 is a diagram illustrating an example of a DM RS pattern defined in the LTE-A system. In FIG. 7, a DM RS is transmitted on one resource block (in case of normal CP, 14 OFDM symbols on the time×12 subcarriers on the frequency) to which downlink data are transmitted. The DM RS may be transmitted for four antenna ports (antenna port indexes 7, 8, 9 and 10) defined additionally in the LTE-A system. The DM RSs for different antenna ports may be identified from one another in such a manner that they are located on different frequency resources (subcarriers) and/or different time resources (OFDM symbols) (that is, the DM RSs may be multiplexed in accordance with FDM and/or TDM mode). Also, the DM RSs for different antenna ports located on the same time-frequency resource may be identified from one another by orthogonal codes (that is, the DM RSs may be multiplexed in accordance with CDM mode). In the example of FIG. 7, the DM RSs for antenna ports 7 and 8 may be located on the resource elements (REs) of DM RS CDM group 1, and may be multiplexed by orthogonal codes. Likewise, in the example of FIG. 7, the DM RSs for antenna ports 9 and 10 may be located on the resource elements (REs) of DM RS group 2, and may be multiplexed by orthogonal codes.

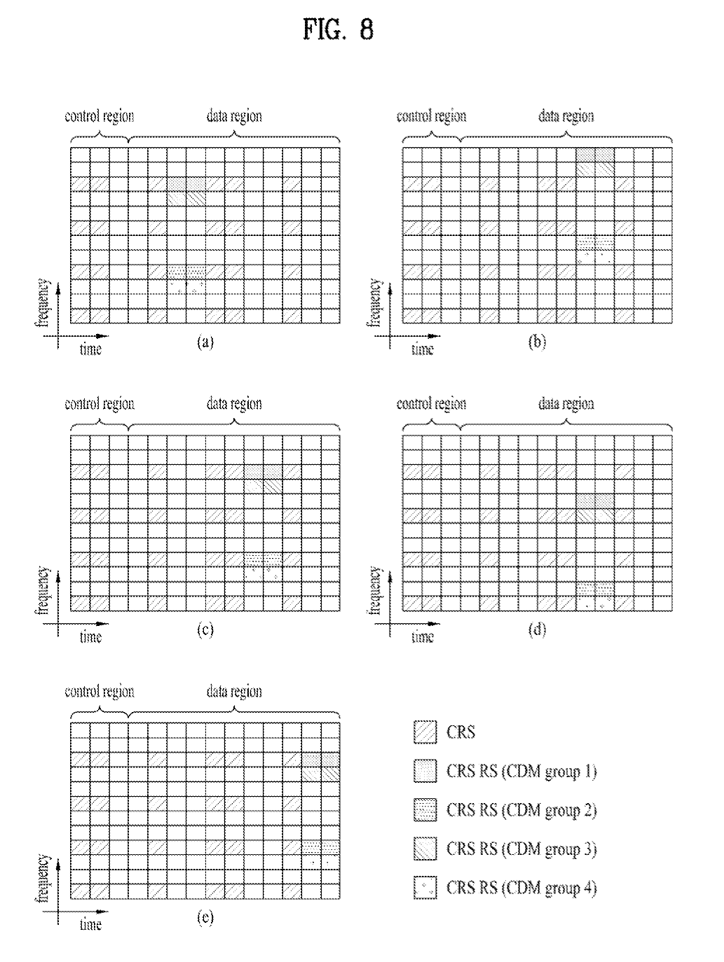

FIG. 8 is a diagram illustrating examples of CSI-RS pattern defined in the LTE-A system. In FIG. 8, CSI-RSs are transmitted on one resource block (in case of normal CP, 14 OFDM symbols on the time×12 subcarriers on the frequency) to which downlink data are transmitted. One of CSI-RS patterns in FIG. 8(a) to FIG. 8(e) may be used for a random downlink subframe. The CSI-RS may be transmitted for eight antenna ports (antenna port indexes 15, 16, 17, 18, 19, 20, 21 and 22) defined additionally in the LTE-A system. The CSI-RSs for different antenna ports may be identified from one another in such a manner that they are located on different frequency resources (subcarriers) and/or different time resources (OFDM symbols) (that is, the CSI-RSs may be multiplexed in accordance with FDM and/or TDM mode). Also, the CSI-RSs for different antenna ports located on the same time-frequency resource may be identified from one another by orthogonal codes (that is, the CSI-RSs may be multiplexed in accordance with CDM mode). In the example of FIG. 8(a), the CSI-RSs for the antenna ports 15 and 16 may be located on the resource elements (REs) of CSI-RS CDM group 1, and may be multiplexed by orthogonal codes. In the example of FIG. 8(a), the CSI-RSs for the antenna ports 17 and 18 may be located on the resource elements (REs) of CSI-RS CDM group 2, and may be multiplexed by orthogonal codes. In the example of FIG. 8(a), the CSI-RSs for the antenna ports 19 and 20 may be located on the resource elements (REs) of CSI-RS CDM group 3, and may be multiplexed by orthogonal codes. In the example of FIG. 8(a), the CSI-RSs for the antenna ports 21 and 22 may be located on the resource elements (REs) of CSI-RS CDM group 4, and may be multiplexed by orthogonal codes. The same principle described based on FIG. 8(a) may be applied to FIG. 8(b) to FIG. 8(e).

The RS patterns of FIG. 6 to FIG. 8 are only exemplary, and various embodiments of the present invention are not limited to a specific RS pattern. In other words, various embodiments of the present invention may equally be applied to a case where RS pattern different from those of FIG. 6 to FIG. 8 is defined and used.

CSI-RS configuration

As described above, in the LTE-A system that supports maximum eight transmitting antenna ports on a downlink, the base station should transmit CSI-RSs for all the antenna ports. In the case that CSI-RSs for maximum eight transmitting antenna ports are transmitted per subframe, a problem occurs in that overhead is too great. Accordingly, in order to reduce overhead, the CSI-RS may intermittently be transmitted on the time axis without being transmitted per subframe. For example, the CSI-RS may be transmitted periodically with an integer multiple period of one frame, or may be transmitted at a specific transmission pattern.

At this time, the transmission period or transmission pattern of the CSI-RS may be configured by the base station. In order to measure the CSI-RS, the user equipment should know CSI-RS configuration for each antenna port of a cell to which the user equipment belongs. CSI-RS configuration may include downlink subframe index for which the CSI-RS is transmitted, time-frequency positions (for example, CSI-RS patterns the same as those of FIG. 8(a) to FIG. 8(e)) of CSI-RS resource elements (REs) within a transmission subframe, and CSI-RS sequence (used for CSI-RS and generated pseudo-randomly in accordance with a predetermined rule on the basis of slot number, cell ID, CP length, etc.). In other words, a plurality of CSI-RS configurations may be used by a given base station, and the base station indicate CSI-RS configuration, which will be used for user equipment(s) within a cell, among the plurality of CSI-RS configurations.

Also, since the CSI-RSs for the respective antenna ports are not required to be identified from one another, resources to which the CSI-RSs for the respective antenna ports are transmitted should be orthogonal to one another. As described with reference to FIG. 8, the CSI-RSs for the respective antenna ports may be multiplexed in accordance with FDM, TDM and/or CDM mode by using orthogonal frequency resources, orthogonal time resources and/or orthogonal code resources.

When the base station notifies the user equipment within the cell of CSI-RS information (CSI-RS configuration), it should first notify the user equipment of time-frequency information into which the CSI-RSs for the respective antenna ports are mapped. In more detail, the time information may include subframe numbers to which the CSI-RSs are transmitted, a transmission period of CSI-RSs, offset of subframe to which the CSI-RSs are transmitted, and OFDM symbol number to which CSI-RS resource element (RE) of a specific antenna is transmitted. The frequency information may include frequency spacing to which CSI-RS resource element (RE) of a specific antenna is transmitted, offset or shift value of RE on a frequency axis, etc.

CSI-RS transmission may be configured in various manners. In order that the user equipment may normally perform channel measurement by receiving the CSI-RSs, the base station needs to notify the user equipment of CSI-RS configuration.

Generally, CSI-RS configuration may be notified from the base station to the user equipment by the following manners.

The first manner is that the base station broadcasts information on CSI-RS configuration to the user equipments by using dynamic broadcast channel (DBCH) signaling.

In the existing LTE system, when notifying the user equipments of system information, the base station may transmit the corresponding information to the user equipments through a broadcast channel (BCH). If the base station cannot transmit the corresponding information to the user equipments due to too much system information, it may transmit the system information by masking PDCCH CRC of corresponding data with a system information identifier (SI-RNTI) not a specific user equipment identifier (for example, C-RNTI) in the same manner as normal downlink data. In this case, actual system information is transmitted on a PDSCH region in the same manner as normal unicast data. Accordingly, all the user equipments within the cell decode the PDCCH by using SI-RNTI and then decode a PDSCH indicated by the corresponding PDCCH, whereby system information may be obtained. This type of broadcasting system may be referred to DBCH system different from a physical BCH (PBCH) system.

A plurality of CSI-RS configurations may be used by a given base station, and the base station may transmit CSI-RS based on each of the CSI-RS configurations to the user equipment on a subframe which is previously determined The base station may notify the user equipment of a plurality of CSI-RS configurations, and especially may notify the user equipment what CSI-RS, which will be used for channel status measurement for feedback of channel quality information (CQI) or channel status information (CSI), is.

If CQI feedback for a specific CSI-RS configuration is requested from the base station, the user equipment may perform channel status measurement by using CSI-RS only which belongs to the corresponding CSI-RS configuration. In more detail, the channel status is determined by CSI-RS received quality, the amount of noise/interference, and a function of correlation coefficients, wherein the CSI-RS received quality is measured using CSI-RS only which belongs to the corresponding CSI-RS configuration, and the amount of noise/interference and the correlation coefficients (for example, interference covariance matrix indicating a direction of interference) may be measured for a corresponding CSI-RS transmission subframe or designated subframes.

For example, the received signal quality measured using CSI-RS is a signal-to-interference plus noise ratio (SINR) and may be expressed briefly by S/(1+N) (S is strength of received signal, I is the amount of interference, and N is the amount of noise). S may be measured through the CSI-RS for a subframe that includes a signal transmitted to the corresponding user equipment. Since I and N are varied depending on the amount of interference from a neighboring cell, a direction of a signal from the neighboring cell, etc., I and N may be measured through the CRS transmitted from a subframe where S is measured or a subframe which is separately designated.

In this case, the amount of noise/interference and the correlation coefficients may be measured through a resource element (RE) to which CRS or CSI-RS within the corresponding subframe, or may be measured through a null resource element configured to easily measure noise/interference. In order to measure noise/interference through the CRS or CSI-RS RE, the user equipment first recovers the CRS or CSI-RS and subtracts the recovered result from the received signal so that noise and interference signal remain only, whereby a statistical value of noisema/interference may be obtained from the remaining noise and interference signal. The null RE means an empty RE (that is, RE having a transmission power of 0(zero)) where the corresponding base station does not transmit any signal, and facilitates signal measurement from other base stations except for the corresponding base station. In order to measure the amount of noise/interference and correlation coefficients, although all of CRS RE, CSI-RS RE, and Null RE may be used, the base station may notify the user equipment of corresponding REs, which will be used to measure noise/interference, among CRS RE, CSI-RS RE, and Null RE. This is because that the corresponding user equipment needs to appropriately designate RE for measurement depending on whether a signal of a neighboring cell, which is transmitted to the RE for performing measurement, is a data signal or a control signal. Since the signal of the neighboring signal transmitted from the corresponding RE is varied depending on inter-cell synchronization, CRS configuration, CSI-RS configuration, etc., the base station may designate the RE for measurement to the user equipment by identifying the signal of the neighboring cell. In other words, the base station may notify the user equipment that the user equipment may use all or some of the CRS RE, the CSI-RS RE, and the Null RE to measure noise/interference.

For example, the base station may use a plurality of CSI-RS configurations, and the base station may notify the user equipment of CSI-RS configuration, which will be used for CQI feedback, and Null RE position when notifying the user equipment of the plurality of CSI-RS configurations. CSI-RS configuration which will be used for CQI feedback may be referred to as CSI-RS configuration in which the signal is transmitted at the transmission power not 0 (non-zero transmission power) unlike Null RE in which the signal is transmitted at the transmission power of 0. For example, the base station may notify the user equipment of one CSI-RS configuration which will be performed for channel measurement by the user equipment, and the user equipment may assume that the CSI-RS is transmitted at the non-zero transmission power through the one CSI-RS configuration. In addition, the base station may notify the user equipment of CSI-RS configuration (that is, Null RE position) in which the signal is transmitted at the transmission power of 0, and the user equipment may assume that the resource element (RE) position of the corresponding CSI-RS configuration corresponds to the transmission power of 0. In other words, the base station may notify the user equipment of the corresponding Null RE position if CSI-RS configuration of the transmission power of 0 exists when notifying the user equipment of one CSI-RS configuration of the non-zero transmission power.

As a modification example of the notification method of the aforementioned CSI-RS configuration, the base station may notify the user equipment of a plurality of CSI-RS configurations, and may notify the user equipment of all or some of the CSI-RS configurations, which will be used for CQI feedback. The user equipment which is requested CQI feedback for a plurality of CSI-RS configurations may measure CQI by using the CSI-RS corresponding to each of the CSI-RS configurations, and may transmit the measured CQI to the base station.

Alternatively, the base station may previously designate uplink resources required for CQI transmission of the user equipment per CSI-RS configuration, so that the user equipment may transmit CQI for each of the plurality of CSI-RS configurations to the base station. Information on the designation of the uplink resources may previously be provided to the user equipment through RRC signaling.

Also, the base station may dynamically perform triggering, so that the user equipment may transmit CQI for each of the plurality of CSI-RS configurations to the base station. Dynamic triggering of CQI transmission may be performed through the PDCCH. CSI-RS configuration for CQI measurement may be notified to the user equipment through the PDCCH. The user equipment that has received the PDCCH may feed the result of CQI measurement for the CSI-RS configuration designated through the corresponding PDCCH back to the base station.

Transmission timing of the CSI-RS corresponding to each of the plurality of CSI-RS configurations may be designated to be transmitted from different subframes, or may be designated to be transmitted from the same subframe. If CSI-RS transmission based on different CSI-RS configurations from the same subframe is designated, it is required to identify different CSI-RSs from one another. In order to identify the CSI-RSs based on different CSI-RS configurations from one another, one or more of time resource, frequency resource and code resource of CSI-RS transmission may be used differently. For example, the RE position to which the CSI-RS is transmitted may be designated at the corresponding subframe differently per CSI-RS configuration (for example, CSI-RS based on one CSI-RS configuration is transmitted from the RE position of FIG. 8(a), and CSI-RS based on the other CSI-RS transmission is transmitted from the RE position of FIG. 8(b)) (identification based on time and frequency resources). Alternatively, if CSI-RSs based on different CSI-RS configurations are transmitted from the same RE position, different CSR-RS scrambling codes may be used by different CSI-RS configurations, whereby the CSI-RSs may be identified from one another (identification based on code resource).

Method for Receiving a Signal in a User Equipment in MU-MIMO System

In the multi user-MIMO (MU-MIMO) system, if the base station transmits data in accordance with a zero forcing beam forming (ZFBF) mode, the user equipment may use the following receiving scheme.

First of all the user equipment may use a maximum ratio combining (MRC) scheme. The MRC scheme is the receiving scheme in which gain of an effective channel for the user equipment is maximized through compensation for a channel used by the user equipment. In the MRC scheme, a received weight vector uₖ of the kth user equipment may be expressed as follows.

$${u}_{k} = \frac{{( {H}_{k} {w}_{k} )}^{H}}{‖ ( {H}_{k} {w}_{k} ) ‖} \qquad [ Equation 14 ]$$

In this case, Hₖ represents a channel matrix of MIMO. wₖ represents a precoding matrix. The operation symbol H represents Hermitian operator, that is, conjugate-transpose operation. Also, the operation symbol T represents transpose operation, and the operation symbol † represents pseudo-inverse operation.

As described above, the MRC scheme is to increase gain for the channel used by the user equipment. Although the MRC scheme is useful if the received signal is damaged by noise, it has a problem in that interference of other user equipment, which occurs in the MU-MIMO system, cannot be removed.

Next, the user equipment may use a zero forcing (ZF) scheme. The ZF scheme may remove interference of other user equipment in the MU-MIMO system. In the ZF scheme, a received weight vector uₖ of the kth user equipment may be expressed as follows.

$${u}_{k} = \frac{U ( k , : )}{‖ U ( k , : ) ‖} \qquad [ Equation 15 ]$$

In this case, the above Equation satisfies the condition of

U=[Hₖwₗ, . . . , Hₖ wₖ, Hₖw_{M}]⁻¹.

As described above, although the ZF scheme may remove a component (interference of other user equipment) corresponding to the other user equipment, it has a problem in that gain for the channel used by the user equipment cannot be increased.

Next, the user equipment may use a Minimum Mean Square Error (MMSE) scheme which is a compromise of the MRC scheme and the ZF scheme. The MMSE scheme is the receiving scheme that improves channel gain and removes channel interference of other user equipment. In the MMSE scheme, a weight vector uₖ may be expressed as follows.

$${u}_{k} = \frac{U ( k , : )}{‖ U ( k , : ) ‖} \qquad [ Equation 16 ]$$

In this case, the above Equation satisfies the condition of

\tilde{H}=[Hₖwₗ, . . . , Hₖwₖ, Hₖw_{M}]⁻¹ U=[\tilde{H}^{H}\tilde{H}+N₀I]⁻¹\tilde{H}^{H}.

As described above, although the MMSE scheme increases channel gain and reduces channel interference of other user equipment, it has a problem in that information on an interference channel of other user equipment is required to obtain an ideal effect.

### Method for Receiving a Signal in Accordance with the Present Invention

In the MU-MIMO system, in order to solve the problem of the MMSE scheme that requires information on an interference channel of other user equipment, a Maximum SINR Combining (MSC) scheme according to the present invention may be used. In more detail, according to the MSC scheme of the present invention, a third vector indicating an effective channel having a maximum SINR may be obtained between a first vector that maximizes channel gain of the user equipment and a second vector that removes channel interference of other user equipment, and a received signal may be processed using a received weight vector determined based on the third vector.

At this time, in the MU-MIMO system, if the base station transmits a signal by using the ZFBF scheme, SINR of the kth user equipment for the received signal may be approximated as follows.

$${SINR}_{k} \approx \frac{{p}_{k} {‖ {h}_{k} ‖}^{2} {cos}^{2} {θ}_{k}}{1 + {p}_{k} {‖ {h}_{k} ‖}^{2} {sin}^{2} {θ}_{k}} \qquad [ Equation 17 ]$$

In this case, pₖ represents a power of the received signal. cos²θₖ and sin²θₖ are terms where an error of an effective channel vector quantized in the ZFBF scheme is approximated. hₖ represents an effective channel vector of the kth user equipment, and satisfies hₖ=Hₖ^{H}uₖ. Also, Hₖ represents a MIMO channel of the kth user equipment, and uk represents the received weight vector of the kth user equipment. In other words, the Equation for obtaining the approximated SINR represents that SINR is determined by effective channel gain (obtained from term //hₖ//²) and an quantization error (obtained form terms cos²θₖ and sin²θₖ).

Also, the MIMO channel Hₖ of the kth user equipment may be decomposed into a basis in a vector space, whereby gain of a unit vector having a random direction on the vector space of the MIMO channel may be expressed as follows.

$$‖ {h}_{k} ‖ = g = \sqrt{1 / {\sum }_{j = 1}^{r} {( \frac{cos {φ}_{j}}{{λ}_{j}^{k}} )}^{2}} \qquad [ Equation 18 ]$$

In this case, λⱼ^{k} represents a singular value corresponding to the jth right singular vector v^{j}ₖ of the MIMO channel of the kth user equipment. φⱼ represents an angle between the unit vector having a random direction and vⱼ^{k}. R represents a rank of the MIMO channel.

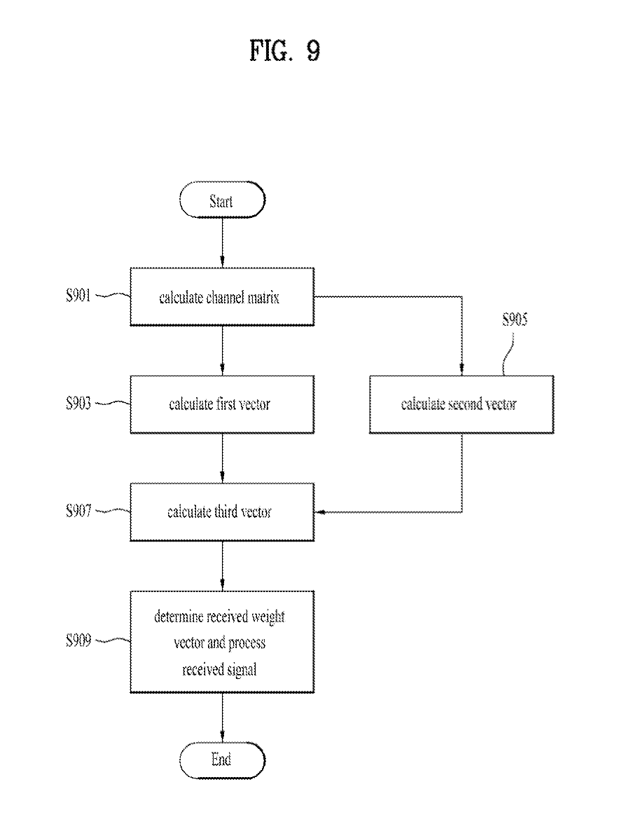

FIG. 9 is a flow chart illustrating a method for receiving a signal in accordance with the present invention.

Referring to FIG. 9, the user equipment calculates a channel matrix on the basis of the reference signal included in the signal received from the base station (S901). Since the reference signal and channel estimation have been described as above, their detailed description will be omitted.

Next, the user equipment calculates a first vector having maximum channel gain in the vector space formed by the channel matrix (S903).

The first vector may be calculated by decomposing the channel matrix in accordance with a singular value decomposition (SVD) scheme. In more detail, the channel matrix of the kth user equipment may be decomposed as follows in accordance with the SVD scheme.

Hₖ=UₖSₖVₖ^{H} [Equation 19]

The matrix Uₖ is orthogonal to the matrix Vₖ, and Sₖ is a diagonal matrix having singular value. In this case, the vector vₗ^{k} corresponding to the greatest singular value in the matrix Vₖ is determined as the first vector.

Also, at the step S903, the first vector may be determined using the following Equation as well as the SVD scheme.

$${\tilde{u}}^{*} = {max}_{{\tilde{u}}_{i}} ‖ {H}_{k}^{H} {\tilde{u}}_{i} ‖ \qquad [ Equation 20 ]$$

In this case, ũᵢ represents unit quantization vectors existing in the user equipment. If the above Equation 12 is used, the first vector vₗ^{k} may be approximated as follows.

$${v}_{1}^{k} \approx \frac{{H}_{k}^{H} {\tilde{u}}^{*}}{‖ {H}_{k}^{H} {\tilde{u}}^{*} ‖} \qquad [ Equation 21 ]$$

The first vector which is approximated may be calculated through the above Equation 21, and the calculation procedure of the Equation 21 is simpler than that of the SVD scheme.

Next, the user equipment determines a second vector, which minimizes an quantization error with the channel matrix, by using a precoding codebook (S905).

Referring to the Equations 17 and 18, the unit vector having a random direction may be referred to as a vector of PMI or a quantization vector of a precoding codebook. At this time, if the number of antennas of the base station is more than that of the user equipment, the second vector, which maximizes SINR, may be expressed as follows.

$${\hat{h}}_{k} = arg {max}_{q} \frac{{p}_{k} {\vert {q}^{H} \overline{q} \vert}^{2} / {\sum }_{j = 1}^{r} {( \frac{cos {φ}_{j}}{{λ}_{j}^{k}} )}^{2}}{1 + {{p}_{k} ( 1 - \vert {q}^{H} \overline{q} \vert )}^{2} / {\sum }_{j = 1}^{r} {( \frac{cos {φ}_{j}}{{λ}_{j}^{k}} )}^{2}} \qquad [ Equation 22 ]$$

In this case, the vector q means a random quantization vector existing in a precoding codebook. q̅ means a quantization vector projected to the channel matrix. If the number of antennas of the base station is more than that of the user equipment, since dimensionality of the quantization vector is smaller than dimensionality of the vector space of the MIMO channel, operation through projection is required.

On the other hand, if the number of antennas of the base station is less than or equal to that of the user equipment, the second vector, which maximizes SINR, may be expressed as follows.

$${\hat{h}}_{k} = arg {max}_{q} 1 / {\sum }_{j = 1}^{r} {( \frac{cos {φ}_{j}}{{λ}_{j}^{k}} )}^{2} \qquad [ Equation 23 ]$$

Also, the second vector may be determined in accordance with the aforementioned method for selecting a quantization vector in accordance with the Equation 1.

Next, the user equipment calculates a third vector, which is located between the first vector and the second vector and indicates an effective channel having a maximum SINR for the received signal (S907).

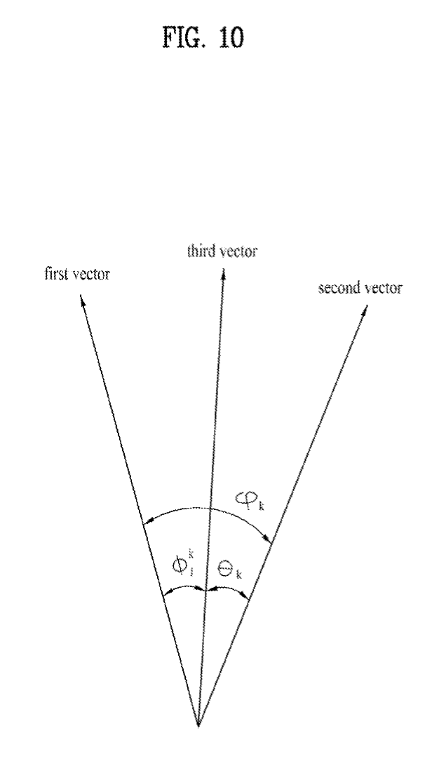

FIG. 10 is a diagram illustrating an example of a method for calculating a third vector in accordance with the present invention. Referring to FIG. 10, the step S907 is to calculate the third vector indicating an effective channel having a maximum SINR for the received signal between the first vector calculated at the step S903 and the second vector determined at the step S905. If the third vector becomes close to the first vector between the first vector and the second vector, the user equipment obtains high channel gain. On the other hand, if the third vector becomes close to the second vector, it is advantageous in that the quantization error is reduced and interference of other user equipment is reduced. Accordingly, the third vector is determined between the first vector and the second vector to indicate the effective channel that maximizes SINR of the received signal.

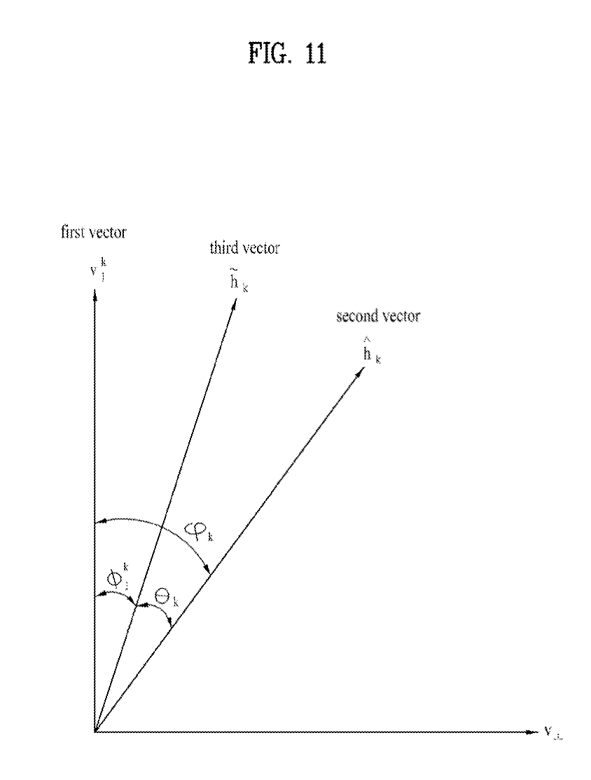

FIG. 11 is a diagram illustrating a third vector when the number of antennas of a base station is smaller than or equal to the number of antennas of a user equipment.

If the number of antennas of the base station is less than or equal to that of the user equipment, the unit effective channel vector \tilde{h}ₖ may be decomposed into Vₗ^{k} and v_{⊥}, whereby the following Equation may be expressed.

\tilde{h}ₖ=(cos φₗ^{k}vₗ^{k}+sin φₗ^{k}v_{⊥})e^{-jψ} [Equation 24]

Referring to the aforementioned Equations 17 and 18 together with the Equation 24, Øₗ^{k}* indicating an angle between the first vector and the third vector may be expressed as follows.

$${φ}_{1}^{{k}^{*}} = arg {max}_{{φ}_{1}^{k}} \frac{{p}_{k} [ \frac{1}{{\sum }_{j = 1}^{r}} {( \frac{1}{{λ}_{j}} )}^{2} \vert {( {v}_{j}^{k} )}^{H} {( \begin{matrix}cos {φ}_{1}^{k} {v}_{1}^{k} + \\ sin {φ}_{1}^{k} {v}_{⊥}\end{matrix} )}^{2} \vert ] {cos}^{2} ( {ϕ}_{k} - {φ}_{1}^{k} )}{\begin{matrix}1 + {p}_{k} [ \frac{1}{{\sum }_{j = 1}^{r}} {( \frac{1}{{λ}_{j}} )}^{2} \vert {( {v}_{j}^{k} )}^{H} {( \begin{matrix}cos {φ}_{1}^{k} {v}_{1}^{k} + \\ sin {φ}_{1}^{k} {v}_{⊥}\end{matrix} )}^{2} \vert ] \\ {sin}^{2} ( {ϕ}_{k} - {φ}_{1}^{k} )\end{matrix}} \qquad [ Equation 25 ]$$

Accordingly, if the number of antennas of the base station is less than or equal to that of the user equipment, the third vector indicating the effective channel, which maximizes SINR of the received signal, may be expressed as follows.

\tilde{h}ₖ*=(cos φₗ^{k}*vₗ^{k}+sin φₗ^{k}*v_{⊥})e^{-ψ} [Equation 26]

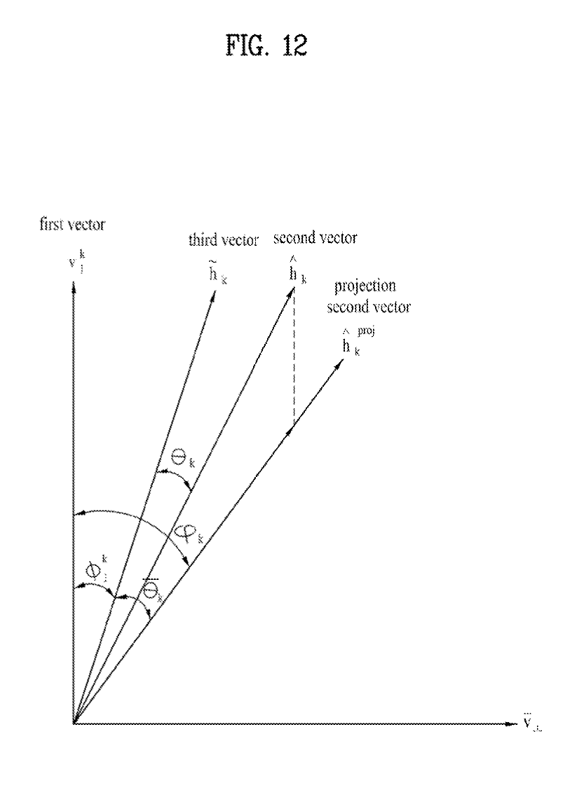

FIG. 12 is a diagram illustrating a third vector when the number of antennas of a base station is greater than the number of antennas of a user equipment.

If the number of antennas of the base station is more than that of the user equipment, the unit effective channel vector \tilde{h}ₖ may be decomposed into vₗ^{k} and v̅_{⊥}, whereby the following Equation may be expressed.

\tilde{h}ₖ=(cos φₗ^{k}vₗ^{k}+sin φₗ^{k} v̅_{⊥})e^{-jψ} [Equation 27]

Referring to the aforementioned Equations 17 and 18 together with the Equation 27, Øₗ^{k}* indicating an angle between the first vector and the third vector may be expressed as follows.

$${φ}_{1}^{{k}^{*}} = arg {max}_{{φ}_{1}^{k}} \frac{\begin{matrix}{p}_{k} [ \frac{1}{{\sum }_{j = 1}^{r}} {( \frac{1}{{λ}_{j}} )}^{2} \vert {( {v}_{j}^{k} )}^{H} {( \begin{matrix}cos {φ}_{1}^{k} {v}_{1}^{k} + \\ sin {φ}_{1}^{k} {\overline{v}}_{⊥}\end{matrix} )}^{2} \vert ] \\ {‖ {q}_{proj} ‖}^{2} {cos}^{2} ( {ϕ}_{k} - {φ}_{1}^{k} )\end{matrix}}{\begin{matrix}1 + {p}_{k} [ \frac{1}{{\sum }_{j = 1}^{r}} {( \frac{1}{{λ}_{j}} )}^{2} \vert {( {v}_{j}^{k} )}^{H} {( \begin{matrix}cos {φ}_{1}^{k} {v}_{1}^{k} + \\ sin {φ}_{1}^{k} {\overline{v}}_{⊥}\end{matrix} )}^{2} \vert ] \\ ( 1 - {‖ {q}_{proj} ‖}^{2} {cos}^{2} ( {ϕ}_{k} - {φ}_{1}^{k} ) )\end{matrix}} \qquad [ Equation 28 ]$$

Accordingly, if the number of antennas of the base station is more than that of the user equipment, the third vector indicating the effective channel, which maximizes SINR of the received signal, may be expressed as follows.

\tilde{h}ₖ*=(cos φₗ^{k}*vₗ^{l}+sin φₗ^{k}* v̅_{⊥})e^{-jψ} [Equation 29]

Next, the user equipment processes the received signal by using the received signal weight vector determined based on the third vector (S909). In more detail, the user equipment may minimize channel interference of other user equipment by using the received weight vector and may increase its channel gain.

The received weight vector uₖ of the kth user equipment may be expressed as follows on the basis of the third vector hₖ* determined at the step S907.

$${u}_{k} = \frac{{( {H}_{k}^{H} )}^{†} {h}_{k}^{*}}{‖ {( {H}_{k}^{H} )}^{†} {h}_{k}^{*} ‖} \qquad [ Equation 30 ]$$

In this case, the operation symbol H represents Hermitian operator, that is, conjugate-transpose operation. Also, the operation symbol † represents pseudo-inverse operation.

In the meantime, the MSC scheme according to the present invention may allow transmission of each layer of multiple users (MU) to correspond to multi layer transmission of a single user (SU).

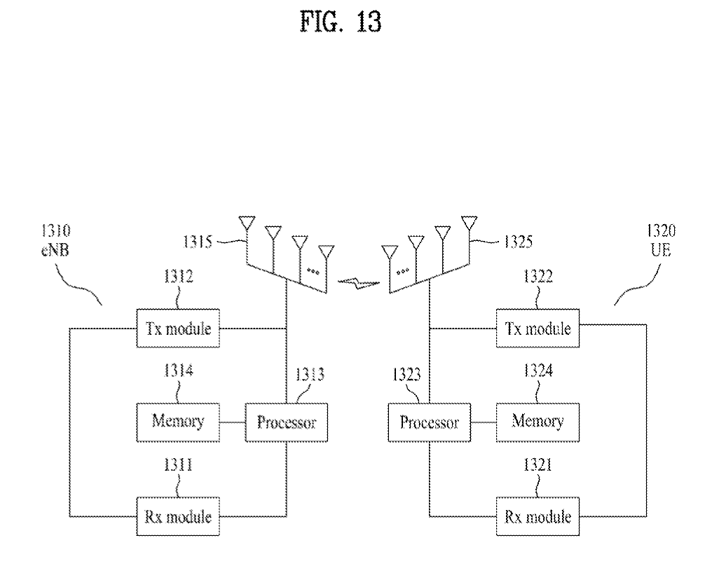

FIG. 13 is a diagram illustrating a base station and a user equipment that may be applied to one embodiment of the present invention.

Referring to FIG. 13, the user equipment 1320 according to the present invention may include a reception module 1321, a transmission module 1322, a processor 1323, a memory 1324, and a plurality of antennas 1325. The plurality of antennas 1325 mean the user equipment that supports MIMO transmission and reception. The reception module 1321 may receive various signals, data and information on a downlink from the base station. The transmission module 1322 may transmit various signals, data and information on an uplink to the base station. The processor 1323 may be configured to implement the procedures and/or methods suggested in the present invention. The memory 1324 may store the operation processed information for a predetermined time and may be replaced with a buffer (not shown).

The base station 1310 may include a reception module 1311, a transmission module 1312, a processor 1313, a memory 1314 and a plurality of antennas 1315. The plurality of antennas 1315 mean the base station that supports MIMO transmission and reception. The reception module 1311 may receive various signals, data and information on an uplink from the user equipment. The transmission module 1312 may transmit various signals, data and information on a downlink to the user equipment. The processor 1313 may be configured to implement the procedures and/or methods suggested in the present invention. The memory 1314 may store the operation processed information for a predetermined time and may be replaced with a buffer (not shown).

The details of the base station and the user equipment described as above may be configured in such a manner that the description suggested in the aforementioned various methods of the present invention may be applied to the base station and the user equipment independently or two or more embodiments may be applied to the base station and the user equipment simultaneously. The repeated details of the base station and the user equipment may be omitted for clarification of description.

Also, in the description of FIG. 13, the description of the base station 1310 may equally be applied to a relay station as a downlink transmission entity or an uplink reception entity, and the description of the user equipment 1320 may equally be applied to a relay station as a downlink reception entity or an uplink transmission entity.

The aforementioned embodiments according to the present invention may be implemented by various means, for example, hardware, firmware, software, or their combination.

If the embodiment of the present invention is implemented by hardware, the method according to the embodiments of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

If the embodiment according to the present invention is implemented by firmware or software, the method according to the embodiments of the present invention may be implemented by a type of a module, a procedure, or a function, which performs functions or operations described as above. A software code may be stored in a memory unit and then may be driven by a processor. The memory unit may be located inside or outside the processor to transmit and receive data to and from the processor through various means which are well known.

Those skilled in the art will appreciate that the present invention may be carried out in other specific ways than those set forth herein without departing from the spirit and essential characteristics of the present invention. It is also obvious to those skilled in the art that claims that are not explicitly cited in each other in the appended claims may be presented in combination as an embodiment of the present invention or included as a new claim by a subsequent amendment after the application is filed.

The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. A method for receiving a signal through a user equipment in a wireless communication system, which supports multi-user-MIMO (MU-MIMO) scheme, the method comprising the steps of:
calculating a channel matrix on the basis of a reference signal included in a signal received from a base station;
calculating a first vector having maximum channel gain in a vector space formed by the channel matrix;
determining a second vector, which minimizes a quantization error with the channel matrix, by using a precoding codebook;
calculating a third vector located between the first vector and the second vector, indicating an effective channel having a maximum signal-to-interference plus noise ratio (SINR) for the received signal; and
processing the received signal by using a received weight vector determined on the basis of the third vector.

2. The method according to claim 1, wherein the SINR is expressed by the following Equation A:
$${SINR}_{k} \approx \frac{{p}_{k} {‖ {h}_{k} ‖}^{2} {cos}^{2} {θ}_{k}}{1 + {p}_{k} {‖ {h}_{k} ‖}^{2} {sin}^{2} {θ}_{k}} \qquad [ Equation A ]$$
where, pₖ represents a power of the received signal, θₖ represents an angle between the first vector and the third vector, and hₖ represents a vector for the effective channel.

3. The method according to claim 1, wherein the first vector is a vector corresponding to the greatest singular vector in a matrix Vₖ if the channel matrix is decomposed as expressed by the following Equation B in accordance with a singular value decomposition (SVD) scheme:
Hₖ=UₖSₖVₖ^{H} [Equation B]
where, Hₖ represents the channel matrix, the matrix Uₖ is orthogonal to the matrix Vₖ, and the matrix Sₖ represents a diagonal matrix having a singular value.

4. The method according to claim 1, wherein the first vector is expressed by the following Equation C:
$${v}_{1}^{k} \approx \frac{{H}_{k}^{H} {\tilde{u}}^{*}}{‖ {H}_{k}^{H} {\tilde{u}}^{*} ‖} \qquad [ Equation C ]$$
where, vₗ^{k} represents the first vector, Hₖ represents the channel matrix, and the following Equation D is satisfied:
$${\tilde{u}}^{*} = {max}_{{\tilde{u}}_{i}} ‖ {H}_{k}^{H} {\tilde{u}}_{i} ‖ \qquad [ Equation D ]$$
where, ũᵢ represents a quantization vector based on a precoding codebook.

5. The method according to claim 1, wherein the second vector is expressed by the following Equation E if the number of antennas of the base station is more than that of the user equipment:
$${\hat{h}}_{k} = arg {max}_{q} \frac{{p}_{k} {\vert {q}^{H} \overline{q} \vert}^{2} / {\sum }_{j = 1}^{r} {( \frac{cos {φ}_{j}}{{λ}_{j}^{k}} )}^{2}}{1 + {{p}_{k} ( 1 - \vert {q}^{H} \overline{q} \vert )}^{2} / {\sum }_{j = 1}^{r} {( \frac{cos {φ}_{j}}{{λ}_{j}^{k}} )}^{2}} \qquad [ Equation E ]$$
where, ĥₖ represents the second vector, pₖ represents a power of the received signal, a vector q represents a quantization vector based on the precoding codebook, a vector q̅ represents the quantization vector projected to the channel matrix, λⱼ^{k} represents a singular value corresponding to the jth right-singular vector of the channel matrix, φⱼ represents an angle between the quantization vector and the right-singular vector, and r represents a rank of the channel matrix.

6. The method according to claim 1, wherein the second vector is expressed by the following Equation F if the number of antennas of the base station is less than or equal to that of the user equipment:
$${\hat{h}}_{k} = arg {max}_{q} 1 / {\sum }_{j = 1}^{r} {( \frac{cos {φ}_{j}}{{λ}_{j}^{k}} )}^{2} \qquad [ Equation F ]$$
where, \tilde{h}ₖ represents the second vector, a vector q represents a quantization vector based on the precoding codebook, λⱼ^{k} represents a singular value corresponding to the jth right-singular vector of the channel matrix, φⱼ represents an angle between the quantization vector and the right-singular vector, and r represents a rank of the channel matrix.

7. The method according to claim 1, wherein the angle between the first vector and the third vector is expressed by the following Equation G if the number of antennas of the base station is less than or equal to that of the user equipment:
$${φ}_{1}^{{k}^{*}} = arg {max}_{{φ}_{1}^{k}} \frac{{p}_{k} [ \frac{1}{{\sum }_{j = 1}^{r}} {( \frac{1}{{λ}_{j}} )}^{2} \vert {( {v}_{j}^{k} )}^{H} {( \begin{matrix}cos {φ}_{1}^{k} {v}_{1}^{k} + \\ sin {φ}_{1}^{k} {v}_{⊥}\end{matrix} )}^{2} \vert ] {cos}^{2} ( {ϕ}_{k} - {φ}_{1}^{k} )}{\begin{matrix}1 + {p}_{k} [ \frac{1}{{\sum }_{j = 1}^{r}} {( \frac{1}{{λ}_{j}} )}^{2} \vert {( {v}_{j}^{k} )}^{H} {( \begin{matrix}cos {φ}_{1}^{k} {v}_{1}^{k} + \\ sin {φ}_{1}^{k} {v}_{⊥}\end{matrix} )}^{2} \vert ] \\ {sin}^{2} ( {ϕ}_{k} - {φ}_{1}^{k} )\end{matrix}} \qquad [ Equation G ]$$
where, Øₗ^{k}* represents the angle between the first vector and the third vector, pₖ represents a power of the received signal, vⱼ^{k} represents the jth right-singular vector of the channel matrix, λⱼ represents a singular value corresponding to the right-singular vector, φₖ represents an angle between the first vector and the second vector, Øₗ^{k} represents the angle between the first vector and the third vector, and vₗ^{k} and v_{⊥} represent that a unit effective channel vector is decomposed.

8. The method according to claim 1, wherein the angle between the first vector and the third vector is expressed by the following Equation H if the number of antennas of the base station is more than that of the user equipment:
$${φ}_{1}^{{k}^{*}} = arg {max}_{{φ}_{1}^{k}} \frac{\begin{matrix}{p}_{k} [ \frac{1}{{\sum }_{j = 1}^{r}} {( \frac{1}{{λ}_{j}} )}^{2} \vert {( {v}_{j}^{k} )}^{H} {( \begin{matrix}cos {φ}_{1}^{k} {v}_{1}^{k} + \\ sin {φ}_{1}^{k} {\overline{v}}_{⊥}\end{matrix} )}^{2} \vert ] \\ {‖ {q}_{proj} ‖}^{2} {cos}^{2} ( {ϕ}_{k} - {φ}_{1}^{k} )\end{matrix}}{\begin{matrix}1 + {p}_{k} [ \frac{1}{{\sum }_{j = 1}^{r}} {( \frac{1}{{λ}_{j}} )}^{2} \vert {( {v}_{j}^{k} )}^{H} {( \begin{matrix}cos {φ}_{1}^{k} {v}_{1}^{k} + \\ sin {φ}_{1}^{k} {\overline{v}}_{⊥}\end{matrix} )}^{2} \vert ] \\ ( 1 - {‖ {q}_{proj} ‖}^{2} {cos}^{2} ( {ϕ}_{k} - {φ}_{1}^{k} ) )\end{matrix}} \qquad [ Equation H ]$$
where, Øₗ^{k}* represents the angle between the first vector and the third vector, pₖ represents a power of the received signal, vⱼ^{k} represents the jth right-singular vector of the channel matrix, λⱼ represents a singular value corresponding to the right-singular vector, Øₖ represents an angle between the first vector and the second vector, Øₗ^{k} represents the angle between the first vector and the third vector, and vₗ^{k} and v̅₁₉₅ represent that a unit effective channel vector is decomposed.

9. The method according to claim 1, wherein the received weight vector is expressed by the following Equation I:
$${u}_{k} = \frac{{( {H}_{k}^{H} )}^{†} {h}_{k}^{*}}{‖ {( {H}_{k}^{H} )}^{†} {h}_{k}^{*} ‖} \qquad [ Equation I ]$$
where, uₖ represents the received weight vector, Hₖ represents the channel matrix, and hₖ* represents the third vector.

10. A user equipment for receiving a signal in a wireless communication system, which supports multi-user-MIMO (MU-MIMO) scheme, the user equipment comprising:
a radio frequency (RF) unit; and
a processor,
wherein the processor is configured to calculate a channel matrix on the basis of a reference signal included in a signal received from a base station, calculate a first vector having maximum channel gain in a vector space formed by the channel matrix, determine a second vector, which minimizes a quantization error with the channel matrix, by using a precoding codebook, calculate a third vector located between the first vector and the second vector, indicating an effective channel having a maximum signal-to-interference plus noise ratio (SINR) for the received signal, and process the received signal by using a received weight vector determined on the basis of the third vector.

11. The user equipment according to claim 10, wherein the SNR is expressed by the following Equation A:
$${SINR}_{k} \approx \frac{{p}_{k} {‖ {h}_{k} ‖}^{2} {cos}^{2} {θ}_{k}}{1 + {p}_{k} {‖ {h}_{k} ‖}^{2} {sin}^{2} {θ}_{k}} \qquad [ Equation A ]$$
where, pₖ represents a power of the received signal, φₖ represents an angle between the first vector and the third vector, and hₖ represents a vector for the effective channel.

12. The user equipment according to claim 10, the angle between the first vector and the third vector is expressed by the following Equation G if the number of antennas of the base station is less than or equal to that of the user equipment:
$${φ}_{1}^{{k}^{*}} = arg {max}_{{φ}_{1}^{k}} \frac{{p}_{k} [ \frac{1}{{\sum }_{j = 1}^{r}} {( \frac{1}{{λ}_{j}} )}^{2} \vert {( {v}_{j}^{k} )}^{H} {( \begin{matrix}cos {φ}_{1}^{k} {v}_{1}^{k} + \\ sin {φ}_{1}^{k} {v}_{⊥}\end{matrix} )}^{2} \vert ] {cos}^{2} ( {ϕ}_{k} - {φ}_{1}^{k} )}{\begin{matrix}1 + {p}_{k} [ \frac{1}{{\sum }_{j = 1}^{r}} {( \frac{1}{{λ}_{j}} )}^{2} \vert {( {v}_{j}^{k} )}^{H} {( \begin{matrix}cos {φ}_{1}^{k} {v}_{1}^{k} + \\ sin {φ}_{1}^{k} {v}_{⊥}\end{matrix} )}^{2} \vert ] \\ {sin}^{2} ( {ϕ}_{k} - {φ}_{1}^{k} )\end{matrix}} \qquad [ Equation G ]$$
where, Øₗ^{k}* represents the angle between the first vector and the third vector, pₖ represents a power of the received signal, vⱼ^{k} represents the jth right-singular vector of the channel matrix, λⱼ represents a singular value corresponding to the right-singular vector, φₖ represents an angle between the first vector and the second vector, Øₗ^{k} represents the angle between the first vector and the third vector, and vₗ^{k} and v_{⊥} represent that a unit effective channel vector is decomposed.

13. The user equipment according to claim 10, wherein the angle between the first vector and the third vector is expressed by the following Equation H if the number of antennas of the base station is more than that of the user equipment:
$${φ}_{1}^{{k}^{*}} = arg {max}_{{φ}_{1}^{k}} \frac{\begin{matrix}{p}_{k} [ \frac{1}{{\sum }_{j = 1}^{r}} {( \frac{1}{{λ}_{j}} )}^{2} \vert {( {v}_{j}^{k} )}^{H} {( \begin{matrix}cos {φ}_{1}^{k} {v}_{1}^{k} + \\ sin {φ}_{1}^{k} {\overline{v}}_{⊥}\end{matrix} )}^{2} \vert ] \\ {‖ {q}_{proj} ‖}^{2} {cos}^{2} ( {ϕ}_{k} - {φ}_{1}^{k} )\end{matrix}}{\begin{matrix}1 + {p}_{k} [ \frac{1}{{\sum }_{j = 1}^{r}} {( \frac{1}{{λ}_{j}} )}^{2} \vert {( {v}_{j}^{k} )}^{H} {( \begin{matrix}cos {φ}_{1}^{k} {v}_{1}^{k} + \\ sin {φ}_{1}^{k} {\overline{v}}_{⊥}\end{matrix} )}^{2} \vert ] \\ ( 1 - {‖ {q}_{proj} ‖}^{2} {cos}^{2} ( {ϕ}_{k} - {φ}_{1}^{k} ) )\end{matrix}} \qquad [ Equation H ]$$
where, Øₗ^{k}* represents the angle between the first vector and the third vector, pₖ represents a power of the received signal, vⱼ^{k} represents the jth right-singular vector of the channel matrix, λⱼ represents a singular value corresponding to the right-singular vector, φₖ represents an angle between the first vector and the second vector, Øₗ^{k} represents the angle between the first vector and the third vector, and vₗ^{k} and v̅_{⊥} represent that a unit effective channel vector is decomposed.

14. The user equipment according to claim 10, wherein the received weight vector is expressed by the following Equation I:
$${u}_{k} = \frac{{( {H}_{k}^{H} )}^{†} {h}_{k}^{*}}{‖ {( {H}_{k}^{H} )}^{†} {h}_{k}^{*} ‖} \qquad [ Equation I ]$$
where, uₖ represents the received weight vector, Hₖ represents the channel matrix, and hₖ* represents the third vector.
